(19) United States
(12) Patent Application Publication
(10) Pub. No.: US 2014/0099349 A1
(43) Pub. Date: Apr. 10, 2014

(54) WOOD PROTECTION AGENT HAVING IMPROVED PENETRATION AND LONG-TERM STABILITY

(71) Applicants: Michael Pallaske, Steinen (DE); Peter Jüngel, Bad Berleburg (DE); Sascha Hellkamp, Bad Berleburg (DE)

(72) Inventors: Michael Pallaske, Steinen (DE); Peter Jüngel, Bad Berleburg (DE); Sascha Hellkamp, Bad Berleburg (DE)

(73) Assignee: KURT OBEMEIER GMBH & CO. KG, Bad Berleburg, DE (DE)

(21) Appl. No.: 14/119,715

(22) PCT Filed: Apr. 30, 2012
(86) PCT No.: PCT/EP2012/001859

§ 371 Date: Nov. 22, 2013

(30) Foreign Application Priority Data
Jun. 10, 2011 (DE) 10 2011 103 955.8

(51) Int. Cl. A01N 25/28; A01N 53/00; A01N 33/08; A01N 43/653

(52) U.S. Cl. CPC A01N 25/28; A01N 43/653; A01N 53/00; A01N 33/08
USPC 424/405; 514/383

(57) ABSTRACT

A water-based wood protection agent having a biocide-containing aqueous emulsion that contains at least one biocide active ingredient and at least one cationic emulsifier, and the at least one biocidal active ingredient is emulsified by the at least one cationic emulsifier to form active ingredient-emulsifier particles, which are each enclosed by an at least single-layered polyelectrolyte coating, so that the net charge of the enclosed particle is zero or negative.

### BACKGROUND OF THE INVENTION

1. Field of the Invention

The present invention relates to wood protection agents having improved penetration and long-term stability and, in particular, water-based wood protection agents comprising active agent emulsions, the emulsion particles of which are enclosed by a polyelectrolyte coating.

2. Description of Related Art

As a consequence of new legal conditions created in the last few years through changes in the German Chemicals Act and the introduction of the Biocidal Products Directive (BPD), there remains only a severely restricted number of biocides available for wood protection. Particularly for the protection of wood in contact with the earth, the use of some well established active agents is either no longer permitted or the ending of the possible use of these agents has been predetermined. At the same time, the sustained use of native wood types for all areas of use where there is contact with the ground or water is not possible without chemical protection measures.

A large number of the biocides currently available for wood protection agents originate from plant protection and are characterized by a relatively good ability to biodegrade in the ground. Whereas a short-lived fungicidal effect is often desirable in the field of plant protection (with degradation of the biocide after 90 days), in the area of wood protection, this is clearly an exclusion criterion. The reason for the relatively short lifespan of organic biocides is usually assumed to be the availability thereof to, and degradability by, ground-living microorganisms (e.g. bacteria). For this reason, in wood protection agents which are provided for the protection of wood in contact with the ground, inter alia, cationic active agents having bactericidal side-effects and belonging to the group of quaternary ammonium compounds (BAC, DDAC, DDAP, ATMAC, etc.) are used as biocides and these can also serve as emulsifiers for additional biocides. However, both the quaternary ammonium compounds and the other organic biocides that are used in wood protection agents are, as ever, biodegradeable, though the quaternary ammonium compounds are usually more slowly degraded than organic biocides, due to the bacterial side-effects in the former. The mutual prolongation of the lifespan of the biocides in different biocide combinations and formulations is known from the prior art.

All cationic compounds, when used in aqueous formulations, show a more or less strong affinity for a wood surface. The positive partial charges of the cationic compounds interact with the static negative partial charges at the wood surface, so that the cationic compounds are immobilized there. This has the result that the protection agent penetrating into the wood in the region close to the surface very rapidly becomes depleted of cationic compounds and only a very small proportion of the cationic compounds reaches the deeper regions in the interior of the wood. In the case of water-insoluble organic biocides which have been emulsified by means of cationic compounds, the same distribution pattern arises. The cationic emulsions preferably break in the region close to the surface, deposit the previously emulsified biocide there and only a very small proportion of the organic biocide reaches the deeper regions in the wood. By masking the positive partial charge of the cationic surfactant with suitable separating agents, the penetration depth can be improved to a limited extent, although a homogeneous active agent distribution in the wood is generally not achieved.

### SUMMARY OF THE INVENTION

It is therefore an object of the present invention to configure the penetration depth of water-based wood protection agents containing cationic active agent emulsions such that the active agent reaches deeper into the inner regions of the wood and is homogeneously distributed in the wood and that, additionally, the greatest possible protection of the active agent is provided against enzymatic degradation by microorganisms.

This object is solved according to the invention in that, in water-based wood protection agents, the cationic surface charge of emulsion particles is neutralized by coating the emulsion particles with suitable polyelectrolytes or is converted into an anionic surface charge and the shell of polyelectrolytes formed on the emulsion particles mechanically prevents the entry of enzymes which could degrade the active agent.

The above and other objects, which will be apparent to those skilled in the art, are achieved in the present invention which is directed to a water-based wood protection agent, comprising a biocide-containing aqueous emulsion which contains at least one biocidal active agent and at least one cationic emulsifier and the at least one biocidal active agent is emulsified by the at least one cationic emulsifier, forming active agent emulsion particles, wherein the active agent emulsion particles are each surrounded by an at least single-layered polyelectrolyte shell, so that the net charge of the coated active agent emulsion particle is zero or negative.

The polyelectrolyte shell may be single-layered and may be formed from an anionic polyelectrolyte. Furthermore, the polyelectrolyte shell may be multiple-layered and may be formed, in alternating manner, from an anionic polyelectrolyte and a cationic polyelectrolyte, the outer layer consisting of an anionic polyelectrolyte. The polyelectrolyte may or may not be biodegradeable. The polyelectrolyte may be modified and/or charged with one or more bactericidally active biocide(s). At least one of the polyelectrolytes is amphoteric and forms a stable polyelectrolyte shell in a pH range from 6 to 14, which polyelectrolyte shell is unstable in a pH range of less than 6.

The polyelectrolyte is preferably selected from the group consisting of acrylamide copolymers, alginates, pectins, polyacrylic acids and corresponding copolymers, polyvinyl sulphuric acid, polycarboxylic acids, polyphosphoric acids, polysaccharides, polystyrene sulphonate, anionically modified polysaccharides and/or polyaminosaccharides as anionic polyelectrolytes (polyanions), and/or phenols, polydiallyldimethylammonium chloride, polyethylene imine, polyvinyl amine, polyvinyl pyridine, polyvinylammonium chloride, cationically modified polysaccharides and/or polyaminosaccharides as cationic polyelectrolytes (polycations).

The at least one amphoteric polyelectrolyte is selected from the group consisting of amphoteric copolymerized polysaccharides and/or chitosans of different chain lengths and/or amphoteric copolymerized polyacrylamides and/or polymeric betaines and/or the amphiphilic copolymers thereof and mixtures thereof.

The cationic emulsifier is preferably a biocidal cationic emulsifier. The biocidal cationic emulsifier may be a quaternary ammonium compound.

The biocidal active agent is preferably selected from fungicides, insecticides, or a combination thereof.

The wood protection agent may also contain an aqueous solution and/or suspension of one or more biocide(s), selected from copper salts, copper complexes, mixed salts, oxides, dialkyldithiocarbamates, dithiocarbamates and diazenium compounds or a combination thereof.

The active agent emulsion particles may be absorbed into nanoscale porous solid particles. The porous solid particles have a mean particle size in the range of 10 nm to 300 nm and are selected from one or more of the group consisting of zeolites, bentonites, kieselguhr, sheet silicates, mesoporous aluminium silicates, mesoporous organosilicates, mesoporous silicates, calcium carbonate, calcium oxide, calcium phosphate, fullerenes, graphenes and mesoporous aluminium compounds.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts the process of changing the surface charge of cationic emulsion particles through the multiple addition of polyelectrolytes of different charge;

FIG. 2 depicts the process of FIG. 1, where before the step of the first addition of polyanions, the porous solid particles are added so that the active agent emulsion particles are transferred into the porous solid particles and initially, a cationic surface charge of the porous solid particles is present; and

FIG. 3 depicts a profile of the active agent content produced at successive distances from the treated wood surface.

### DESCRIPTION OF THE PREFERRED EMBODIMENT(S)

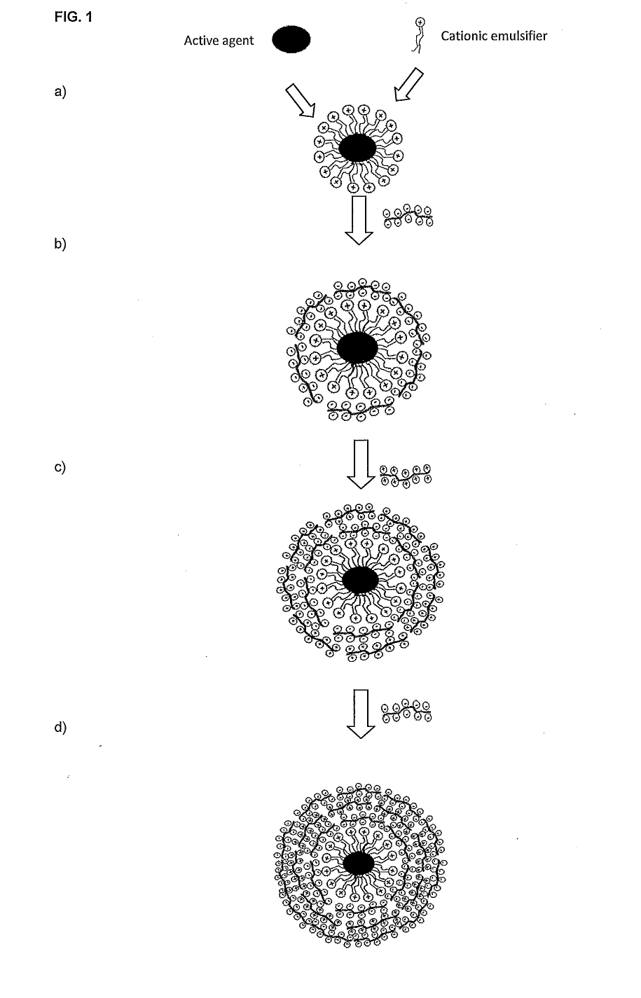

In describing the preferred embodiment of the present invention, reference will be made herein to FIGS. 1-3 of the drawings in which like numerals refer to like features of the invention.

The present invention therefore provides a water-based wood protection agent comprising a biocide-containing aqueous emulsion which contains at least one biocidal active agent and at least one cationic emulsifier and the at least one biocidal active agent is emulsified by the at least one cationic emulsifier, forming active agent emulsion particles, wherein the active agent emulsion particles are each surrounded by an at least single-layered polyelectrolyte shell, so that the net charge of the coated active agent emulsion particle is zero or negative.

In the wood protection agent according to the invention, the penetration properties of the biocides are significantly improved by neutralization of the cationic surface charge of the emulsion particles or by transfer thereof to an anionic surface charge and, in the pressure process method, an almost homogenous active agent distribution across the impregnated region is achieved. Furthermore, due the mechanical protection of the polyelectrolyte coating, the biological degradation of the active agents of the emulsion particles is extensively delayed or prevented and the protective effect of the wood protection agent is significantly prolonged. Finally, due to the mechanical immobilization of the emulsion particles, active agent losses due to washing out and evaporation from the wood are minimized and the environmental properties of treated wood are markedly improved.

According to one embodiment of the present invention, the polyelectrolyte shell is single-layered and is formed from an anionic polyelectrolyte.

According to a preferred embodiment of the present invention, the polyelectrolyte shell is multiple-layered and is formed, in alternating manner, from an anionic polyelectrolyte and a cationic polyelectrolyte, the outer layer consisting of an anionic polyelectrolyte. This preferred embodiment ensures by mechanical means that practically no microbial exoenzymes are able to penetrate into the coated emulsion particles and bring about the biological degradation of the active agent. In a further preferred embodiment, three polyelectrolyte layers, particularly preferably five or more polyelectrolyte layers are present.

The process of changing the surface charge of cationic emulsion particles through the multiple addition of polyelectrolytes of different charge is shown by way of example in FIG. 1. According to step a) in FIG. 1, initially, the uniting of an active agent particle with molecules of a cationic emulsifier generates an emulsion particle which has a positive surface charge, due to the cationic emulsifier. Then, in step b), polyanions are added which, due to the opposite charge thereof, become deposited on the surface of the emulsion particle and form a homogeneous negatively charged shell around the emulsion particle. Then, in step c), polycations are added which, due to the opposite charge thereof, become deposited on the surface of the polyanion shell of the emulsion particle and form a homogeneous positively charged shell around the emulsion particle. Due to the deposition of a second polyelectrolyte shell, the pore size, that is, the size of the intermediate spaces between the individual polyelectrolyte molecules, is significantly reduced. In a final step d), polyanions are again added which, due to the opposite charge thereof, become deposited on the surface of the polycation shell of the emulsion particle and form a homogeneous negatively charged shell round the emulsion particle. Due to the deposition of a third polyelectrolyte shell, the pore size is still further reduced. This procedure is known from other specialist fields and is designated “layer-by-layer deposition” technology.

As mentioned above, the multiple-layered coating has the consequence that the accessibility of the coated active agent for microbial exoenzymes is greatly restricted or even entirely prevented, so that biological degradation of the active agent by the exoenzymes is correspondingly severely reduced or entirely prevented.

Depending on the polyelectrolyte(s) used and the number of polyelectrolyte layers in the shell, the pore size that can be reached is in the range of 1 nm to 30 nm, preferably 5 nm to 15 nm. The pore size is determined, in known manner, by transmission electron microscopy, for example with a transmission electron microscope of the type JEM-2100 from JEOL Ltd. of Tokyo, Japan.

According to the invention, any cationic emulsifier that is known to a person skilled in the relevant art can be used as the cationic emulsifier. Examples of suitable cationic emulsifiers include quaternary ammonium compounds and quaternary phosphonium compounds or a combination thereof.

However, in order to amplify the effect of the wood protection agent according to the invention, the cationic emulsifier according to a preferred embodiment of the present invention is a biocidal cationic emulsifier. Examples of suitable biocidal cationic emulsifiers include quaternary ammonium compounds, for example, chloride, bromide, borate, propionate, lactate, benzoate and/or carbonate salts of 1,1′-dimethyl-4,4′-bipyridinium, N-benzyl-2-(2,6-dimethylphenylamino)-N,N-diethyl-2-oxoethanaminium, alkyldimethylbenzylammonium, benzyldimethyltetradecylammonium, benzyldimethyldodecylammonium, didecyldimethylammonium, cocoalkyltrimethylammonium, didecylpolyoxyethylammonium, N,N-didecyl-N-methyl-poly-(oxyethyl)-ammonium, diisobutylphenoxyethoxyethyldimethylbenzylammonium, 1-hexadecylpyridinium, hexadecyltrimethylammonium, tetrabutylammonium, and the acetate, chloride, bromide, borate, iodide, propionate and/or carbonate salts of quaternary phosphonium compounds, for example, benzyltriphenylphosphonium, butyltriphenylphosphonium, ethyltriphenylphosphonium, methyltriphenylphosphonium, tetraphenylphosphonium, or a combination thereof.

Due to the favorable properties of a particularly good emulsifying capability with a simultaneously good biocidal, particularly bactericidal effect, according to a preferred embodiment of the present invention, the biocidal cationic emulsifier is a quaternary ammonium compound.

Examples of suitable quaternary ammonium compounds include chloride, bromide, borate, propionate and/or carbonate salts of N,N-bis(3-aminopropyl)-dodecylammonium, alkyldimethylbenzylammonium, benzyldimethyltetradecylammonium, benzyldimethyldodecylammonium, didecyldimethylammonium, cocoalkyltrimethylammonium, didecylpolyoxyethylammonium and N,N-didecyl-N-methyl-poly-(oxyethyl)-ammonium.

According to a preferred embodiment of the present invention, the biocidal active agent is selected from fungicides, insecticides or a combination thereof.

As fungicides, the following compounds can be used individually or in a combination:

triazoles, such as amitrole, azocyclotin, BAS 480F, bitertanol, difenoconazole, fenbuconazole, fenchlorazole, fenethanil, fluquinconazole, flusilazole, flutriafol, imibenconazole, isazofos, myclobutanil, Opus, paclobutrazol, penconazole, tetraconazole, triadimefon, triadimenol, triapenthenol, triflumizole, uniconazole, 2-(1-chlorocyclopropyl)-1-(2-chlorophenyl)-3-(1H-1,2,4-triazol-1-yl)propan-2-ol, 2-(tert-butyl)-1-(2-chlorophenyl)-3-(1H-1,2,4-triazol-1-yl)propan-2-ol, (±)-cis-1-(4-chlorophenyl)-2-(1H-1,2,4-triazol-1-yl)-cycloheptanol, azaconazole (1-{[2-{2,4-dichlorophenyl)-1,3-dioxolan-2-yl]methyl}-1H-1,2,4-triazol), propiconazole (1-[2-(2,4-dichlorophenyl)-4-propyl-1,3-dioxolan-2-yl]methyl-1H-1,2,4-triazole), tebuconazole (1-p-chlorophenyl-4,4-dimethyl-3(1H-1,2,4-triazol-1-yl-methyl)pentan-3-ol), cyproconazole (2-(4-chlorophenyl)-3-cyclopropyl-1-(1H-1,2,4-triazol-1-yl)butan-2-ol, metconazole (5-[(4-chlorophenyl)methyl]-2,2-dimethyl-1-(1H-1,2,4-triazol-1-yl-methyl)cyclopentanol;

imidazoles such as imazalil, perfurazoate, prochloraz, triflumizole, 2-(1-tert-butyl)-1-(2-chlorophenyl)-3-(1,2,4-triazol-1-yl)-propan-2-ol;

thiazolecarboxanilides, such as 2′,6′-dibromo-2-methyl-4-trifluoromethoxy-4′-trifluoromethyl-1,3-thiazole-5-carboxanilide;

succinate dehydrogenase inhibitors, such as fenfuram, furcarbanil, cyclafluramid, furmecyclox, seedvax, metsulfovax, pyrocarbolid, oxycarboxin, shirlan, mebenil (mepronil), benodanil, flutolanil (Moncut);

naphthalene derivatives, such as terbinafine, naftifine, butenafine, 3-chloro-7-(2-aza-2,7,7-trimethyl-oct-3-en-5-yne);

sulphenamides, such as dichlorfluanid, tolylfluanid, folpet, fluorofolpet; captan, captofol;

benzimidazoles, such as carbendazim, benomyl, furathiocarb, fuberidazole, thiophonate-methyl;

thiabendazole or the salts thereof;

thiocyanates, such as thiocyanatomethylthiobenzothiazole, methylene bisthiocyanate;

morpholine derivatives, such as tridemorph, fenpropimorph, falimorph, dimethomorph, dodemorph, aldimorph, fenpropidin and the arylsulphonic acid salts thereof, for example the toluene sulphonic acid or p-dodecylphenylsulfonic acid salts thereof;

iodine derivatives such as diiodomethyl-p-tolyl sulfone, 3-iodo-2-propynyl alcohol, 4-chlorophenyl-3-iodopropargylformal, 3-bromo-2,3-diiodo-2-propenylethylcarbamate, 2,3,3-triiodoallyl alcohol, 3-bromo-2,3-diiodo-2-propenyl alcohol, 6-iodo-3-oxo-hex-5-ynol-butylcarbamate, 6-iodo-3-oxo-hex-5-ynol-phenylcarbamate, 3-iodo-2-propynyl-n-hexylcarbamate, 3-iodo-2-propynyl-cyclohexylcarbamate, 3-iodo-2-propynyl-phenylcarbamate, 3-iodo-2-propynyl-butylcarbamate;

phenol derivatives, such as tribromophenol, tetrachlorophenol, 3-methyl-4-chlorophenyl, dichlorophene, o-phenylphenol, m-phenylphenol, p-phenylphenol, 2-benzyl-4-chlorophenol;

bromine derivatives, such as 2-bromo-2-nitro-1,3-nitro-1,3-propanediol;

isothiazolinones, such as N-methylisothiazolin-3-one, 5-chloro-N-methylisothiazolin-3-one, 4,5-dichloro-N-octylisothiazolin-3-one, 4,5-dichloro-2-octyl-2H-isothiazol-3-one, N-octyl-isothiazolin-3-one, benzisothiazolinone, 4,5-trimethylene-isothiazolinone;

pyridines or pyrimidines, such as 1-Hydroxy-2-pyridinthion and the Na, Fe, Mn and Zn salts thereof, tetrachloro-4-methylsulfonylpyridine, pyrimethanil, mepanipyrim, dipyrithion;

metallic soaps, such as tin, copper or zinc naphthenate, octoate, -2-ethylhexanoate, oleate, phosphate or benzoate;

dialkyldithiocarbamates, such as Na and Zn salts of dialkyldithiocarbamates, tetramethylthiuram disulphide;

dithiocarbamates, cufraneb, ferbam, mancopper, mancozeb, maneb, metam, metiram, thiram, zineb, ziram;

nitriles, such as 2,4,5,6-tetrachloroisophthalodinitrile, 2,3,5,6-tetrafluoroterephthalodinitrile;

benzathiazoles, such as 2-mercaptobenzothiazole;

quinolines, such as 8-hdroxyquinoline and the Cu salts thereof;

benzamides, such as 2,6-dichloro-N-(4-trifluoromethylbenzyl)-benzamide (XRD-563);

boron compounds, such as boron salts, boric acid esters, borax, boron oxide, disodium octaborate tetrahydrate, disodium tetraborate;

formaldehyde and formaldehyde-releasing compounds, such as benzyl alcohol mono(poly)hemiformal, oxazolidine, hexahydro-S-triazine, N-methylol chloroacetamide, paraformaldehyde, nitropyrin, oxolinic acid, tecloftalam; and

salts of sorbic acid, such as sodium sorbate, potassium sorbate.

Further fungicides can be selected from the group consisting of acypetacs, 2-aminobutane, ampropylfos, anilazine, benalaxyl, bupirimate, chinomethionat, chlorfenapyr, chloroneb, chlozolinate, cymoxanil, dazomet, diclomezine, dichlofluanid, dichloram, diethofencarb, dimethirimol, dinocab, dithianon, dodine, drazoxolon, edifenphos, ethirimol, etridiazole, fenarimol, fenitropan, fentin acetate, fentin, fentin hydroxide, ferimzone, fluazinam, fluoromide, flusulfamide, flutriafol, fosetyl, fthalide, furalaxyl, glutaraldehyde, guazatine, hymexazol, iprobenfos, iprodione, isoprothiolane, metalaxyl, methasulfocarb, nitrothal isopropyl, nuarimol, ofurace, oxadiyl, perflurazoate, pencycuron, phosdiphen, pimaricin, piperalin, procymidone, propamocarb, propineb, pyrazophos, pyrifenox, pyroquilone, quintozene, tar oils, tecnazene, thicyofen, thiophanate-methyl, tolclofos-methyl, tolylfluanid, triazoxide, trichlamide, tricyclazole, triforine, vinclozolin, or a combination thereof.

As insecticides, for example, the following compounds can be used individually or in a combination:

phosphoric acid esters, such as azinphos-ethyl, azinphos-methyl, α-1-(4-chlorophenyl)-4-(O-ethyl, S-propyl)phosphoryloxypyrazole, chlorpyrifos, coumaphos, demeton, demeton-S-methyl, diazinon, dichlorvos, dimethoate, ethoate, ethoprophos, etrimfos, fenitrothion, fenthion, heptenophos, parathion, parathion-methyl, phosalone, phoxim, pirimiphos-ethyl, pirimiphos-methyl, profenofos, prothiofos, sulfprofos, triazophos and trichlorphon;

carbamates, such as aldicarb, bendiocarb, α-2-(1-methylpropyl)-phenylmethylcarbamate, butocarboxim, butoxycarboxim, carbaryl, carbofuran, carbosulfan, cloethocarb, isoprocarb, methomyl, oxamyl, pirimicarb, promecarb, propoxur and thiodicarb;

organosilicon compounds, such as dimethyl(phenyl)silyl-methyl-3-phenoxybenzylether or dimethyl-(4-ethoxyphenyl)silylmethyl-3-phenoxybenzylether or (dimethylphenyl)-silyl-methyl-2-phenoxy-6-pyridylmethylether, for example, dimethyl-(9-ethoxy-phenyl)-silylmethyl-2-phenoxy-6-pyridylmethylether, or [(phenyl)-3-(3-phenoxyphenyl)-propyl](dimethyl)-silanes, for example, (4-ethoxyphenyl)-[3-(4-fluoro-3-phenoxyphenylpropyl]dimethylsilane, silafluofen;

pyrethroids, such as allethrin, alphamethrin, bioresmethrin, byfenthrin, cycloprothrin, cyfluthrin, decamethrin, cyhalothrin, cypermethrin, deltamethrin, α-cyano-3-phenyl-2-methylbenzyl-2,2-dimethyl-3-(2-chloro-2-trifluoromethylvinyl)cyclopropane carboxylate, etofenprox, fenpropathrin, fenfluthrin, fenvalerate, flucythrinate, flumethrin, fluvalinate, permethrin, pyrethrum, resmethrin and tralomethrin;

nitroimines and nitromethylenes, such as 1-[{6-chloro-3-pyridinyl)-methyl]-4,5-dihydro-N-nitro-1H-imidazol-2-amine (imidacloprid), N-[(6-chloro-3-pyridyl)methyl-]N2-cyano-N1-methylacetamide; and

benzoyl ureas, such as chlorfluazuron, diflubenzuron, flufenoxuron, flucycloxuron, hexaflumuron, penfluoron, teflubenzuron, triflumuron and other development inhibitors, such as benzoic acid-[2-benzoyl-1-(1,1-dimethylethyl)]-hydrazide, 2,6-dimethoxy-N-[5]-4-(pentafluoroethoxy)-phenyl-[2,3,4-thiadiazol-2-yl]-benzamide, N-cyclopropyl-1,3,5-triazine-2,4-triamine, 2-(4-phenoxyphenoxy)-ethylethylcarbamate, 1-(decycloxy)-4-[(6-methoxy-4-hexinyl)-oxy]benzene, (2-propynyl)-4-methoxybenzoate, fenoxycarb, pyriproxyfen, triarathene, thiapronil, hexythiazox, clofentezine, 4-chloro-5-(6-chloro-3-pyridylmethoxy)-2-(3,4-dichlorophenyl)-pyridazin-3(2H)-one, buprofezin, hydroprene, kinoprene, methoprene, cycloprate, gusathin, Padan, paraxon, Tribunil and triprene.

Further insecticides can be selected from the group consisting of abamectin, AC 303,630, acephate, acrinathrin, alanycarb, aldoxycarb, aldrin, ammonium bifluoride, amitraz, azamethiphos, Bacillus thuringiensis, phosmet, phosphamidon, phosphine, prallethrin, propaphos, propetamphos, prothoate, pyraclofos, pyrethrins, pyridaben, pyridafenthion, pyriproxyfen, quinalphos, RH-7988, rotenone, sulfotep, tar oil, teflubenzuron, tefluthrin, temephos, terbufos, tetrachlorvinphos, tetramethrin, 0-2-tert-butylpyrimidin-5-yl-o-isopropylphosphorothiate, thiacloprid, thiocyclam, thiofanox, thiometon, tralomethrin, triflumuron, trimethacarb, vamidothion, xylylcarb, benfuracarb, bensultap, bifenthrin, bioallethrin, merbioaliethrin-(S)-cyclopentenyl isomer, bromophos, bromophos-ethyl, buprofezin, cadusafos, calcium polysulphide, carbophenothion, cartap, chinomethionat, chlordane, chlorfenvinphos, chlorfluazuron, chlormephos, chloropicrin, chlorpyrifos, cyanophos, beta-cyfluthrin, alpha-cypermethrin, cyophenothrin, cyromazine, dazomet, DDT, demeton-S-methyl sulphone, diafenthiuron, dialifos, dicrotophos, diflubenzuron, dinoseb, dioxabenzofos, diaxacarb, disulfoton, DNOC, empenthrin, endosulfan, EPN, esfenvalerate, ethiofencarb, ethion, etofenprox, fenobucarb, fenoxycarb, fensulfothion, fipronil, flucycloxuron, flufenprox, flufenoxuron, fonofos, formetanate, formothion, fosmethilan, furathiocarb, heptachlor, hexaflumuron, hydramethylnon, hydroprene, IPSP, isazofos, isofenphos, isoprothiolane, isoxathion, iodofenphos, kadethrin, lindane, malathion, mecarbam, mephosfolan, metam, methacrifos, methamidophos, methidathion, methiocarb, methoprene, methoxychlor, methyl-isothiocyanate, metholcarb, mevinphos, monocrotophos, naled, nicotine, omethoate, oxydemeton-methyl, pentachlorophenol, phenothrin, phenthoate, phorate, or a combination thereof.

According to a preferred embodiment of the present invention, the wood protection agent also contains an aqueous solution and/or a suspension of one or more biocide(s) selected from copper salts, copper complexes, mixed salts, oxides, dialkyldithiocarbamates, dithiocarbamates and diazenium compounds or a combination thereof. The addition of an aqueous solution and/or suspension of this type can further enhance the biocidal properties of the wood protection agent or can be used for a particular specific case of use.

Examples of suitable copper salts include copper sulphate, carbonate, hydroxide carbonate, dihydroxide, or chloride, copper ammonia complexes, copper amine complexes and copper diazenium complexes, as well as copper sulphate, carbonate, hydroxide carbonate and chloride as particles in a micronized form (particle size in the range of 30 nm to 5000 nm, preferably in the range of 50 nm to 800 nm).

Examples of suitable mixed salts include copper/boron salt mixtures, copper/chromium/boron salt mixtures and copper/chromium/arsenic salt mixtures.

Examples of suitable oxides include tributyl tin oxide, Cu₂O, CuO and ZnO.

Examples of suitable dialkyldithiocarbamates include Na and Zn salts of dialkyldithiocarbamates and of tetramethylthiuram disulphide.

Examples of suitable dithiocarbamates include cufraneb, ferbam, mancopper, mancozeb, maneb, metam, metiram, thiram, zineb and ziram.

Examples of suitable diazenium compounds include tris-N-(cyclohexyldiazeniumdioxy)-aluminium, N-(cyclohexyldiazeniumdioxy)tributyltin, N-(cyclohexyldiazeniumdioxy)-potassium and bis-N-(cyclohexyldiazeniumdioxy)-copper.

According to a preferred embodiment of the present invention, the polyelectrolyte(s) is/are not biodegradeable. This applies particularly for the last, outermost polyelectrolyte shell, which is intended, by the chemical composition thereof, to be as inaccessible as possible for bacterial degradation, in order to protect the internally situated biocides reliably against such degradation and to increase the lifespan of said biocides in the wood.

According to a preferred embodiment of the present invention, the polyelectrolyte(s) is/are modified and/or charged with one or more bactericidally active biocide(s). The modification or charging of the polyelectrolyte(s) further increases the long-term stability of the wood protection agent because a bactericidal effect exists even at the outer shell of the individual emulsion particles and thus the action of exoenzymes on the active agent is severely reduced, including in the case of a single-layered polyelectrolyte shell. This applies, in particular, in the case that the last, outermost situated polyelectrolyte shell cannot be protected by means of the chemical composition thereof against bacterial degradation. In such a situation, one or each polyelectrolyte shell can be equipped with one or more bactericidally active substance(s) which are fixed onto the shell either by means of the ionic character of said active substances (for example, heavy metal ions such as silver, zinc, copper, etc.) and/or by van der Waals bonds (for example, isothiazolinones, antibiotics, etc.), and/or serve as copolymers in the polyelectrolyte (for example, betaines, polymeric betaines, etc.).

According to a preferred embodiment of the present invention, the polyelectrolyte(s) is/are selected from the group consisting of anionic polyelectrolytes (polyanions), for example, acrylamide copolymers, alginates, pectins, polyacrylic acids and corresponding copolymers, polyvinyl sulphuric acid, polycarboxylic acids, polyphosphoric acids, polysaccharides, polystyrene sulphonate, anionically modified polysaccharides and/or polyaminosaccharides, and/or cationic polyelectrolytes (polycations), for example, phenols, polydiallyldimethylammonium chloride, polyethylene imine, polyvinyl amine, polyvinyl pyridine, polyvinylammonium chloride, cationically modified polysaccharides and/or polyaminosaccharides.

Particularly preferably, as anionic polyelectrolytes, such as are based on polystyrene sulphonate (PSS), polyacrylic acid, anionically polymerised polysaccharides and/or the amphiphilic copolymers thereof and mixtures thereof are used, and as cationic polyelectrolytes, particularly preferably such as are based on polyethylene imine, polymers with condensed aromatic cyclic compounds, polyallyl amine, cationically copolymerised polysaccharides, polybetaines and/or the amphiphilic copolymers thereof and mixtures thereof are used.

A particularly advantageous effect according to the invention is obtained if, as anionic polyelectrolytes, such as are based on polyacrylic acid and/or chitosan and the amphiphilic copolymers thereof and mixtures thereof are used and, as cationic polyelectrolytes, such as are based on polyethylene imine, polymers with condensed aromatic cyclic compounds, polyallyl amine, polybetaines, chitosan and/or the amphiphilic copolymers thereof and mixtures thereof are used.

According to a preferred embodiment of the present invention, at least one of the polyelectrolytes is amphoteric and forms a stable polyelectrolyte shell in a pH range from 6 to 14, preferably from 7 to 11, which is unstable in a pH range of <6, preferably in a pH range from 2 to 4. In this embodiment, the coated emulsion particles are released again when the pH of the surroundings in which the emulsion particle is situated falls below a value of 6, preferably in a range of 2 to 4. By this means, the biocides are deposited in the wood in a form that is, as far as possible, not bioavailable and are only released in the event of an active attack on the wood by wood-destroying fungi and the reduction in the pH value thereby caused. In this way, the potential for harm to the user from the wood treated with the wood protection agent according to the invention is significantly reduced because the biocides are no longer present freely distributed in the wood, but are only released when needed.

According to a preferred embodiment of the present invention, as amphoteric polyelectrolytes, for example, amphoteric copolymerised polysaccharides and/or chitosans of different chain lengths and/or amphoteric copolymerised polyacrylamides and/or polymeric betaines and/or the amphiphilic copolymers thereof and mixtures thereof are used.

Particularly preferably, as amphoteric polyeletrolytes, for example, chitosans of different chain lengths and/or amphoteric copolymerised polyacrylamides and/or polymeric betaines and/or the amphiphilic copolymers thereof and mixtures thereof are used. A particularly advantageous effect according to the invention is obtained if, as amphoteric polyeletrolytes, chitosans of different chain lengths and/or amphoteric copolymerised polyacrylamides and/or the amphiphilic copolymers thereof and mixtures thereof are used.

According to a preferred embodiment of the present invention, the active agent emulsion particles are taken up into nanoscale, porous solid particles.

Particularly preferably, the porous solid particles have a mean particle size in the range of 10 nm to 300 nm and are selected from one or more of the group consisting of zeolites, bentonites, kieselguhr, sheet silicates, mesoporous aluminium silicates, mesoporous organosilicates, mesoporous silicates, calcium carbonate, calcium oxide, calcium phosphate, fullerenes, graphenes and mesoporous aluminium compounds.

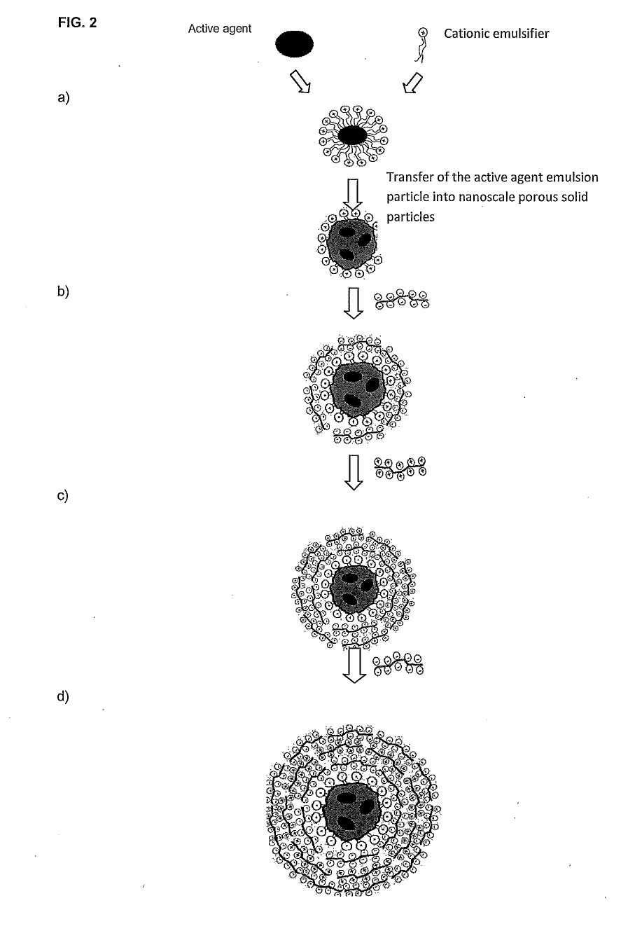

The procedure for changing the surface charge of cationic emulsion particles through multiple addition of polyelectrolytes with different charges in the event that the above-named porous solid particles are used is, in principle, identical to the procedure shown in FIG. 1, although before the step of the first addition of polyanions, the porous solid particles are added so that the active agent emulsion particles are transferred into the porous solid particles and initially, a cationic surface charge of the porous solid particles is present. This process is shown schematically in FIG. 2. FIG. 2 will not be discussed in further detail since it is otherwise identical to FIG. 1

The wood protection agent according to the invention is preferably formulated such that, in the ready-to-use form, said agent contains in the range of 0.001% to 15% by weight of the at least one biocidal active agent, 0.01% to 30% by weight of the at least one cationic emulsifier, 0.01% to 30% by weight of polyelectrolyte and optionally 0.01% to 30% by weight of one or more biocides selected from copper salts, copper complexes, mixed salts, oxides, dialkyldithiocarbamates, dithiocarbamates and diazenium compounds or a combination thereof in a complexed, dissolved or dispersed form.

The wood protection agent according to the invention is more preferably formulated to contain in the range of 0.005% to 5% by weight of the at least one biocidal active agent, 0.1% to 10% by weight of the at least one cationic emulsifier, 0.1% to 30% by weight of polyelectrolyte and optionally 0.1% to 25% by weight of one or more biocides selected from copper salts, copper complexes, mixed salts, oxides, dialkyldithiocarbamates, dithiocarbamates and diazenium compounds or a combination thereof in a complexed, dissolved or dispersed form.

The wood protection agent according to the invention is particularly formulated to contain in the range of 0.01% to 0.5% by weight of the at least one biocidal active agent, 0.1% to 10% by weight of the at least one cationic emulsifier, 0.1% to 30% by weight of polyelectrolyte and optionally 0.5% to 20% by weight of one or more biocides selected from copper salts, copper complexes, mixed salts, oxides, dialkyldithiocarbamates, dithiocarbamates and diazenium compounds or a combination thereof in a complexed, dissolved or dispersed form.

If the aforementioned nanoscale porous solid particles are used, said particles are present in the wood protection agent according to the invention in a proportion in the range of 0.01% to 15% by weight and preferably 0.1% to 10% by weight, in particular 1% to 5% by weight.

The present invention will now be disclosed further with examples, although these should not be understood as having any limiting effect.

### EXAMPLES

### Example 1

Example of a wood protection agent formulation according to the invention which contains an active agent with a polyelectrolyte layer.

The following starting materials were used in the proportions shown in Table 1:

TABLE 1

| | % by | |
|---|---|---|
| Starting substance | weight | Function |
| Propiconazole | 0.2 | Biocide (fungicide) |
| Cypermethrin | 0.02 | Biocide (insecticide) |
| Dipropylene glycol methyl ether | 0.2 | Cosolvent |
| Bardap 26 | 2.0 | Biocide (fungicide) and |
| [N,N-didecyl-N-methyl- | | cationic emulsifier |
| poly(oxyethyl)ammonium propionate] | | |
| PAM/AA A-2 | 4.0 | Polyanion (20 mol-% |
| [poly(acrylamide-co-Na-acrylate)] | | ionic groups) |
| Water | to 100 | Solvent |

Propiconazole and cypermethrin were initially dissolved in dipropylene glycol methyl ether and the solution obtained was added to Bardap 26, after which the mixture was converted in known manner into a microemulsion by shearing. Following the addition of water, the mixture was stirred and PAM/AA A-2 was added, after which stirring was continued. After the final addition of water, stirring was continued until a homogeneous emulsion was obtained.

### Example 2

Example of a wood protection agent formulation according to the invention which contains an active agent with a polyelectrolyte layer making use of a nanoscale porous template.

The following starting materials were used in the proportions shown in Table 2:

TABLE 2

| | % by | |
|---|---|---|
| Starting substance | weight | Function |
| Propiconazole | 0.2 | Biocide (fungicide) |
| Cypermethrin | 0.02 | Biocide (insecticide) |
| Dipropylene glycol methyl ether | 0.2 | Cosolvent |
| Bardap 26 | 2.0 | Biocide (fungicide) and |
| [N,N-didecyl-N-methyl- | | cationic emulsifier |
| poly(oxyethyl)ammonium propionate] | | |
| Zeolite | 6 | Microporous aluminium |
| | | silicate (80 nm particle |
| | | size) |
| PAM/AA A-2 | 4.0 | Polyanion (20 mol-% |
| [poly(acrylamide-co-Na-acrylate)] | | ionic groups) |
| Water | to 100 | Solvent |

Propiconazole and cypermethrin were initially dissolved in dipropylene glycol methyl ether and the solution obtained was added to Bardap 26, after which the mixture was converted in known manner into a microemulsion by shearing. The microporous zeolite was introduced into the microemulsion and, following the addition of water, the mixture was stirred and PAM/AA A-2 was added, after which stirring was continued. After the final addition of water, stirring was continued until a homogeneous emulsion was obtained.

### Example 3

Example of a wood protection agent formulation according to the invention which contains an active agent with three polyelectrolyte layers

The following starting materials were used in the proportions shown in Table 3:

TABLE 3

| | % by | |
|---|---|---|
| Starting substance | weight | Function |
| Propiconazole | 0.2 | Biocide (fungicide) |
| Cypermethrin | 0.02 | Biocide (insecticide) |
| Dipropylene glycol methyl ether | 0.2 | Cosolvent |
| Bardap 26 | 2.0 | Biocide (fungicide) and |
| [N,N-didecyl-N-methyl- | | cationic emulsifier |
| poly(oxyethyl)ammonium propionate] | | |
| PAM/AA A-2 | 10.0 | Polyanion (20 mol-% |
| [poly(acrylamide-co-Na-acrylate)] | | ionic groups) |
| Poly-DADMAC | 5.0 | Polycation (100 mol-% |
| [poly(diallyldimethylammonium)- | | ionic groups) |
| chloride] | | |
| Water | to 100 | Solvent |

Propiconazole and cypermethrin were initially dissolved in dipropylene glycol methyl ether and the solution obtained was added to Bardap 26, after which the mixture was converted in known manner into a microemulsion by shearing. Following the addition of water, the mixture was stirred and PAM/AA A-2 was added, after which stirring was continued. Following the removal of free dissolved PAM/AA A-2, poly-DADMAC was added, after which stirring was continued. Finally, free dissolved poly-DADMAC was removed and further PAM/AA A-2 was added, after which stirring was continued. After the final addition of water, stirring was continued until a homogeneous emulsion was obtained.

### Example 4

Example of a wood protection agent formulation according to the invention which contains an active agent with three polyelectrolyte layers making use of a nanoscale porous template.

The following starting materials were used in the proportions shown in Table 4:

TABLE 4

| | % by | |
|---|---|---|
| Starting substance | weight | Function |
| Propiconazole | 0.2 | Biocide (fungicide) |
| Cypermethrin | 0.02 | Biocide (insecticide) |
| Dipropylene glycol methyl ether | 0.2 | Cosolvent |
| Bardap 26 | 2.0 | Biocide (fungicide) and |
| [N,N-didecyl-N-methyl- | | cationic emulsifier |
| poly(oxyethyl)ammonium propionate | | |
| Zeolite | 6 | Microporous aluminium |
| | | silicate (80 nm particle |
| | | size) |
| PAM/AA A-2 | 10.0 | Polyanion (20 mol-% |
| [poly(acrylamide-co-Na-acrylate)] | | ionic groups) |
| Poly-DADMAC | 5.0 | Polycation (100 mol-% |
| [poly(diallyldimethylammonium)- | | ionic groups) |
| chloride] | | |
| Water | to 100 | Solvent |

Propiconazole and cypermethrin were initially dissolved in dipropylene glycol methyl ether and the solution obtained was added to Bardap 26, after which the mixture was converted in known manner into a microemulsion by shearing. The microporous zeolite was introduced into the microemulsion and, following the addition of water, the mixture was stirred and PAM/AA A-2 was added, after which stirring was continued. Following the removal of free dissolved PAM/AA A-2, poly-DADMAC was added, after which stirring was continued. Finally, free dissolved poly-DADMAC was removed and further PAM/AA A-2 was added, after which stirring was continued. After the final addition of water, stirring was continued until a homogeneous emulsion was obtained.

### Comparative Example

Example of a wood protection agent formulation not according to the invention which contains an active agent without a polyelectrolyte layer.

The following starting materials were used in the proportions shown in Table 5:

TABLE 5

| | % by | |
|---|---|---|
| Starting substance | weight | Function |
| Propiconazole | 0.2 | Biocide (fungicide) |
| Cypermethrin | 0.02 | Biocide (insecticide) |
| Dipropylene glycol methyl ether | 0.2 | Cosolvent |
| Bardap 26 | 2.0 | Biocide (fungicide) and |
| [N,N-didecyl-N-methyl- | | cationic emulsifier |
| poly(oxyethyl)ammonium propionate] | | |
| Water | to 100 | Solvent |

Propiconazole and cypermethrin were initially dissolved in dipropylene glycol methyl ether and the solution obtained was added to Bardap 26, after which the mixture was converted in known manner into a microemulsion by shearing. After the addition of water, stirring was continued until a homogeneous emulsion was obtained.

Determination of the distribution of the biocides in the wood was carried out as follows:
planing off a defined wood layer from the wood surface;
collecting the wood shavings thereby produced;
weighing the wood shavings;
extracting the active agent from the wood shavings;
analysing the quantity of active agent in the shavings;
normalising the active agent quantity found to the weight of the shavings;
converting into grammes of active agent per cubic metre of wood.

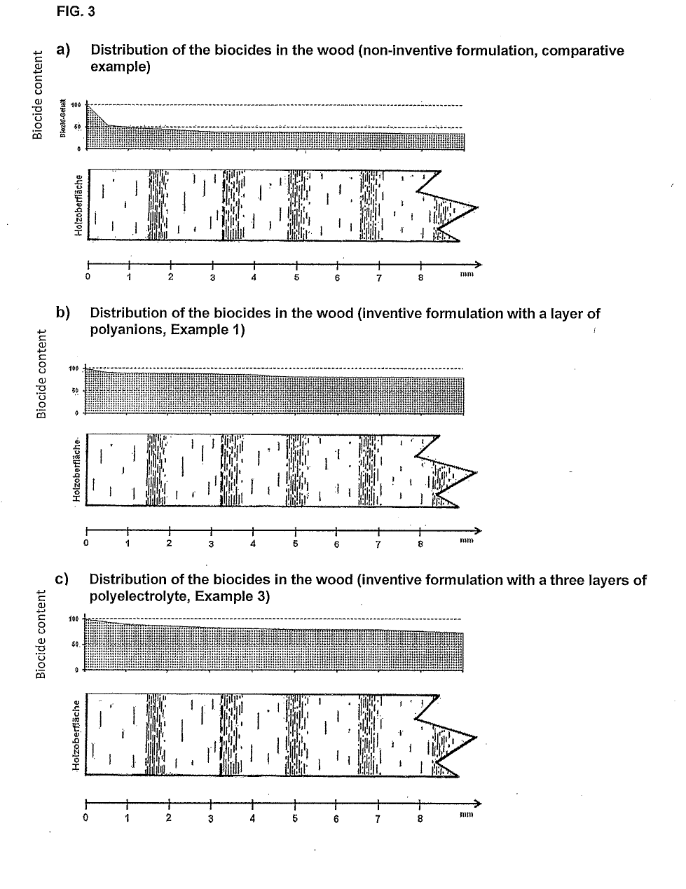

By means of the planing and analyzing of a plurality of successive wood layers, a profile of the active agent content is thereby produced at successive distances from the treated wood surface, as shown in FIG. 3.

As shown in FIG. 3a, in the case of the non-inventive formulation of the comparative example, the concentration of the biocide in deeper layers is very much smaller than with the formulations according to the invention (Examples 1 and 3), as FIGS. 3b and 3c show. Furthermore, FIG. 3a shows that the concentration of the biocide falls off very rapidly even after approximately 0.5 mm penetration depth, to approximately half, whereas in FIGS. 3b and 3c, the concentration falls off only very slowly and a high concentration was measured up to a penetration depth of approximately 8 mm. With the formulation according to the invention as per Example 3, which is represented in FIG. 3c, it is also apparent that the presence of three polyelectrolyte layers leads, as compared with Example 1 in which only one polyelectrolyte layer exists, to a somewhat lower concentration of the biocide in deeper layers of the wood. However, this disadvantage is compensated for in that through the presence of three polyelectrolyte layers, it is ensured by mechanical means that practically no microbial exoenzymes are able to penetrate into the coated emulsion particles to bring about the biological degradation of the active agent.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A water-based wood protection agent, comprising a biocide-containing aqueous emulsion which contains at least one biocidal active agent and at least one cationic emulsifier and the at least one biocidal active agent is emulsified by the at least one cationic emulsifier, forming active agent emulsion particles, wherein the active agent emulsion particles are each surrounded by an at least single-layered polyelectrolyte shell, so that the net charge of the coated active agent emulsion particle is zero or negative.

2. The wood protection agent of claim 1, wherein the polyelectrolyte shell is single-layered and is formed from an anionic polyelectrolyte.

3. The wood protection agent of claim 1, wherein the polyelectrolyte shell is multiple-layered and is formed, in alternating manner, from an anionic polyelectrolyte and a cationic polyelectrolyte, the outer layer consisting of an anionic polyelectrolyte.

4. The wood protection agent of claim 1, wherein the cationic emulsifier is a biocidal cationic emulsifier.

5. The wood protection agent according to claim 4, wherein the biocidal cationic emulsifier is a quaternary ammonium compound.

6. The wood protection agent of claim 1, wherein the biocidal active agent is selected from fungicides, insecticides, or a combination thereof.

7. The wood protection agent of claim 1, which also contains an aqueous solution and/or suspension of one or more biocide(s), selected from copper salts, copper complexes, mixed salts, oxides, dialkyldithiocarbamates, dithiocarbamates and diazenium compounds or a combination thereof.

8. The wood protection agent according to claim 1, wherein the polyelectrolyte is not biodegradeable.

9. The wood protection agent of claim 1, wherein the polyelectrolyte is modified and/or charged with one or more bactericidally active biocide(s).

10. The wood protection agent of claim 1, wherein, at least one of the polyelectrolytes is amphoteric and forms a stable polyelectrolyte shell in a pH range from 6 to 14, which polyelectrolyte shell is unstable in a pH range of less than 6.

11. The wood protection agent of claim 1, wherein the polyelectrolyte is selected from the group consisting of acrylamide copolymers, alginates, pectins, polyacrylic acids and corresponding copolymers, polyvinyl sulphuric acid, polycarboxylic acids, polyphosphoric acids, polysaccharides, polystyrene sulphonate, anionically modified polysaccharides and/or polyaminosaccharides as anionic polyelectrolytes (polyanions), and/or phenols, polydiallyldimethylammonium chloride, polyethylene imine, polyvinyl amine, polyvinyl pyridine, polyvinylammonium chloride, cationically modified polysaccharides and/or polyaminosaccharides as cationic polyelectrolytes (polycations).

12. The wood protection agent of claim 10, wherein the at least one amphoteric polyelectrolyte is selected from the group consisting of amphoteric copolymerized polysaccharides and/or chitosans of different chain lengths and/or amphoteric copolymerized polyacrylamides and/or polymeric betaines and/or the amphiphilic copolymers thereof and mixtures thereof.

13. The wood protection agent of claim 1, wherein, the active agent emulsion particles are absorbed into nanoscale porous solid particles.

14. The wood protection agent according to claim 13, wherein the porous solid particles have a mean particle size in the range of 10 nm to 300 nm and are selected from one or more of the group consisting of zeolites, bentonites, kieselguhr, sheet silicates, mesoporous aluminium silicates, mesoporous organosilicates, mesoporous silicates, calcium carbonate, calcium oxide, calcium phosphate, fullerenes, graphenes and mesoporous aluminium compounds.

15. The wood protection agent of claim 2, wherein the cationic emulsifier is a biocidal cationic emulsifier.

16. The wood protection agent according to claim 15, wherein the biocidal cationic emulsifier is a quaternary ammonium compound.

17. The wood protection agent of claim 3, wherein the biocidal active agent is selected from fungicides, insecticides, or a combination thereof.

18. The wood protection agent of claim 5, wherein the biocidal active agent is selected from fungicides, insecticides, or a combination thereof.

19. The wood protection agent of claim 2, which also contains an aqueous solution and/or suspension of one or more biocide(s), selected from copper salts, copper complexes, mixed salts, oxides, dialkyldithiocarbamates, dithiocarbamates and diazenium compounds or a combination thereof.

20. The wood protection agent of claim 3, which also contains an aqueous solution and/or suspension of one or more biocide(s), selected from copper salts, copper complexes, mixed salts, oxides, dialkyldithiocarbamates, dithiocarbamates and diazenium compounds or a combination thereof.

21. The wood protection agent of claim 6, which also contains an aqueous solution and/or suspension of one or more biocide(s), selected from copper salts, copper complexes, mixed salts, oxides, dialkyldithiocarbamates, dithiocarbamates and diazenium compounds or a combination thereof.

22. The wood protection agent according to claim 2, wherein the polyelectrolyte- is not biodegradeable.

23. The wood protection agent according to claim 3, wherein the polyelectrolyte- is not biodegradeable.

24. The wood protection agent of claim 2, wherein the polyelectrolyte is modified and/or charged with one or more bactericidally active biocide(s).

25. The wood protection agent of claim 3, wherein the polyelectrolyte is modified and/or charged with one or more bactericidally active biocide(s).

26. The wood protection agent of claim 8, wherein the polyelectrolyte is modified and/or charged with one or more bactericidally active biocide(s).

27. The wood protection agent of claim 2, wherein, at least one of the polyelectrolytes is amphoteric and forms a stable polyelectrolyte shell in a pH range from 6 to 14, which polyelectrolyte shell is unstable in a pH range of less than 6.

28. The wood protection agent of claim 9, wherein, at least one of the polyelectrolytes is amphoteric and forms a stable polyelectrolyte shell in a pH range from 6 to 14, which polyelectrolyte shell is unstable in a pH range of less than 6.

29. The wood protection agent of claim 3, wherein the polyelectrolyte is selected from the group consisting of acrylamide copolymers, alginates, pectins, polyacrylic acids and corresponding copolymers, polyvinyl sulphuric acid, polycarboxylic acids, polyphosphoric acids, polysaccharides, polystyrene sulphonate, anionically modified polysaccharides and/or polyaminosaccharides as anionic polyelectrolytes (polyanions), and/or phenols, polydiallyldimethylammonium chloride, polyethylene imine, polyvinyl amine, polyvinyl pyridine, polyvinylammonium chloride, cationically modified polysaccharides and/or polyaminosaccharides as cationic polyelectrolytes (polycations).

30. The wood protection agent of claim 9, wherein the polyelectrolyte is selected from the group consisting of acrylamide copolymers, alginates, pectins, polyacrylic acids and corresponding copolymers, polyvinyl sulphuric acid, polycarboxylic acids, polyphosphoric acids, polysaccharides, polystyrene sulphonate, anionically modified polysaccharides and/or polyaminosaccharides as anionic polyelectrolytes (polyanions), and/or phenols, polydiallyldimethylammonium chloride, polyethylene imine, polyvinyl amine, polyvinyl pyridine, polyvinylammonium chloride, cationically modified polysaccharides and/or polyaminosaccharides as cationic polyelectrolytes (polycations).

31. The wood protection agent of claim 30, wherein the at least one amphoteric polyelectrolyte is selected from the group consisting of amphoteric copolymerized polysaccharides and/or chitosans of different chain lengths and/or amphoteric copolymerized polyacrylamides and/or polymeric betaines and/or the amphiphilic copolymers thereof and mixtures thereof.
